(19) United States
(12) Patent Application Publication
(10) Pub. No.: US 2003/0161475 A1
(43) Pub. Date: Aug. 28, 2003

(54) Encryption of digitized physical information based on physical tags

(76) Inventors: James D. Crumly, Boise, ID (US); Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/086,771

(22) Filed: Feb. 28, 2002

(51) Int. Cl. H04L 9/00

(52) U.S. Cl. 380/280; 713/185

(57) ABSTRACT

Methods and apparatus for encrypting an image produced from physical information. The physical information may be associated with a physical tag that identifies a public key. The physical information may be digitized to create a digital image, and the physical tag may be digitized to create a digital tag that is readable to identify the public key. The digital tag may be read to identify the public key, and then the image encrypted with the identified public key.

### FIELD OF THE INVENTION

The present invention relates generally to encryption of digital images. More specifically, the present invention relates to encryption of digital images created from physical information associated with physical tags.

### BACKGROUND OF THE INVENTION

Security is a fundamental concern for those that send digital information over a network. In many cases, a sender and a recipient need to be relatively confident about the identity of one another during an information exchange. In this exchange, the sender needs to be confident that misrouted, or, worse yet, stolen digital information will be intelligible only to intended recipients, particularly when the information is proprietary in nature.

Cryptography with asymmetric key pairs provides a general solution to problems of network security. An asymmetric key pair includes a public key and a corresponding private key. The key pair provides bi-directional encrypting and decoding capabilities for digital information using an algorithm. Specifically, the public key is used with the algorithm to 1) encrypt data that is decodable with the private key and 2) decode data that was encrypted with the private key. The public key and private key are usually very large numbers and thus provide a unique key pair that cannot be identified easily by a trial-and-error approach.

The broad usefulness and secure nature of an asymmetric key pair is determined by the differential availability of each key. The public key is not maintained in secret, but is shared widely, which allows many to use this portion of the key pair in communications with the corresponding key holder. In contrast, the security of the key pair lies with the private key. The private key itself is maintained in secret by the key holder and is not directly shared with others. Instead, the private key allows the key holder to decode information that has been encrypted by another, using the key holder's public key. This encrypted information is not intelligible to others, allowing only the key holder of the private key to decode and understand the encrypted information. Additional aspects of key pairs, including encrypting, decoding, and suitable algorithms are described, for example, in U.S. Pat. No. 4,200,770 to Hellman et al., U.S. Pat. No. 4,405,829 to Rivest et al., and U.S. Pat. No. 4,893,338 to Pastor. The subject matter of these patents is incorporated herein by this reference thereto.

The certainty with which a specific user or device is identified by a key pair is based on a model of trust. This model of trust uses a trusted entity, such as an institution, person, or persons, to provide an assurance that the correct identity of the user or device is linked to a public/private key pair. For example, a trusted institution, termed a certificate authority, may issue key pairs to users. The certificate authority may rely on standard identifying documents, such as a driver's license and a passport, to verify that the correct identity is linked to the key pair. The public key then may be bundled into a digital certificate, which typically includes the public key and identifying information about the key holder. An aspect of the digital certificate, such as size plus content, is frequently encrypted with the certificate authority's private key, forming a digital signature, which minimizes the possibility of modification or forgery. Therefore, the digital certificate provides others with confidence that the public key is linked to an accurately identified owner. The level of confidence of identification is generally proportional to the trust others place in the trusted authority. Digital signatures and certificates are described further, for example, in U.S. Pat. No. 4,625,076 to Okamoto et al., and U.S. Pat. No. 4,868,877 to Fischer, both of which are incorporated herein by this reference.

In order to encrypt and send information, the information may be digitized, associated with a public key, and then encrypted by an encryption algorithm, using the public key. When the information is digitized with a keyboard interface and then sent electronically, encrypting and sending the digitized information are often combined seamlessly. For example, a key holder wishing to receive encrypted, digitized information may send a message, which includes the key holder's public key, to a potential sender. Mail software may be used to link this public key to the key holder's return address, so that a response sent to the key holder's address may be selectively encrypted with the public key. Thus, activities related to creating a digital response on a keyboard/display interface and sending the response by electronic mail are readily linked to accessing a stored public key.

However, in many cases, a sender wishes to send a digital image produced from spatially-distributed physical information, for example, a facsimile transmission of a signed document sent to a recipient. Generally, the document is converted to the digital image using a digitizing mechanism, such as a digital scanner, and then sent directly to the recipient based on the recipient's electronic address or telephone number. If the recipient has provided the sender with the recipient's digital public key, the sender may encrypt the digital image with the public key by manually associating the public key with the digital image of the document to allow encryption. However, a keyboard/display interface and an additional set of manipulations for linking the digital public key to the digital image increase the time and cost related to sending the digital image. In addition, these manipulations may result in errors. For example, the sender may inadvertently link the digital image to the wrong public key and/or address, wasting additional time and potentially sending decodable information to an unintended recipient.

### SUMMARY OF THE INVENTION

The present invention provides methods and apparatus for encrypting an image produced from physical information. The physical information may be associated with a physical tag that identifies a public key. The physical information may be digitized to create a digital image, and the physical tag may be digitized to create a digital tag that is readable to identify the public key. The digital tag may be read to identify the public key, and then the image encrypted with the identified public key.

### BRIEF DESCRIPTION OF THE FIGURES

FIG. 1 is an environmental view of a system in which an image of a document may be encrypted using a public key identified by a physical tag associated with the document, in accordance with an embodiment of the present invention.

FIG. 2 is a top plan view of a document associated with a physical tag for use in the system of FIG. 1, in accordance with an embodiment of the present invention.

FIG. 3 is a top plan view of the physical tag from the document of FIG. 2.

FIG. 4 is a top plan view of an alternative physical tag for association with a document, in accordance with an embodiment of the present invention.

FIG. 5 is a top plan view of yet another physical tag for association with a document, in accordance with an embodiment of the present invention.

FIG. 6 is a flow diagram illustrating a method for encrypting and sending an image of a document using a public key and a recipient address identified by a physical tag associated with the document, in accordance with an embodiment of the present invention.

### DETAILED DESCRIPTION OF THE INVENTION

The present invention provides methods and apparatus for encrypting a digital image produced from spatially-distributed physical information using a public key identified by a physical tag associated with the physical information. The methods and apparatus convert the physical information and physical tag to a digital image and a digital tag, respectively, using at least one digitizing mechanism. The physical tag may identify the public key using optically readable information including a code, such as a linear or two-dimensional barcode; characters; and/or symbols, among others. The identified public key may be included fully in the physical and corresponding digital tags or may be stored at a distinct location identified by the tags, such as a distinct region on a document carrying the physical tag, a public key server, or a local digital storage site, among others. The public key is used to encrypt the digital image, including or lacking the digital tag.

Once encrypted, the encrypted image may be sent to a recipient that holds a counterpart private key for the public key. However, prior to sending, the original or encrypted digital image may be signed with a digital signature generated with the sender's private key. The encrypted image then may be sent to the recipient, based on an address included in, or identified by, the physical and digital tags. Upon receipt, the recipient may use the counterpart private key to decode the encrypted image, followed by optional printing or viewing. With the use of physical tags to facilitate automatic encryption, the present invention provides secure methods, which may be both streamlined and reliable, for transmitting images of documents that include text, handwriting, sketches, drawings, and/or photographs, among others.

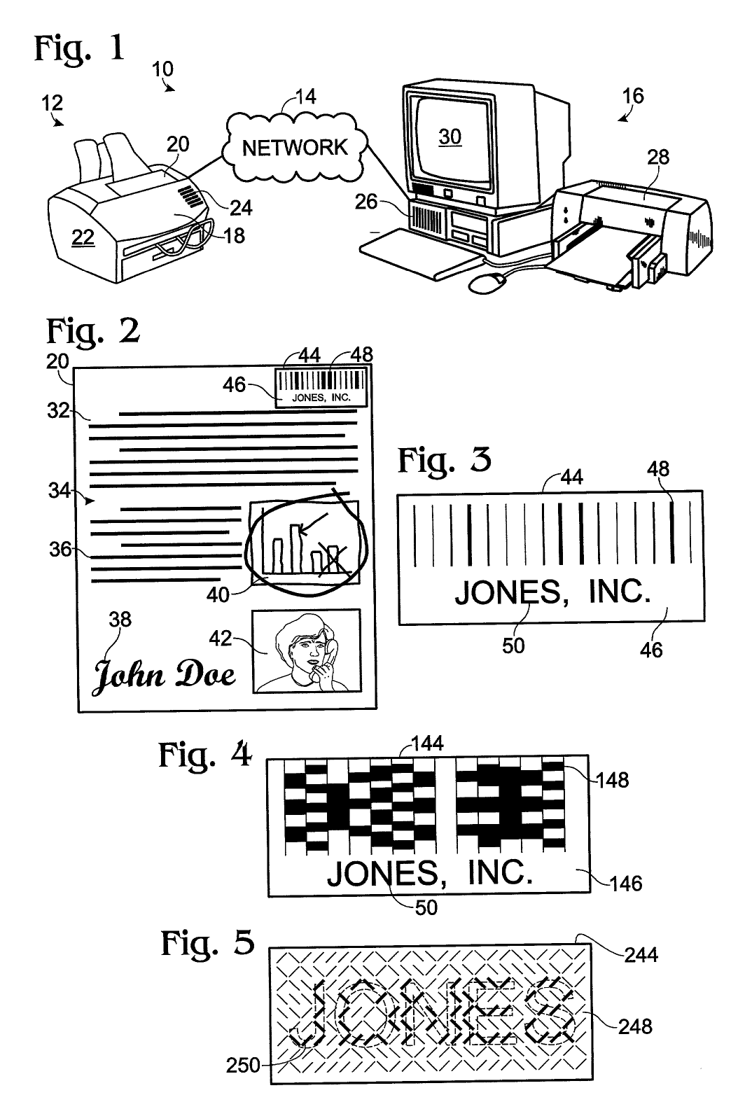

A system for carrying out the present invention is shown in FIG. 1 at 10. In the present illustration, system 10 includes a sending device 12 connected through a network 14 to a receiving device 16. Sending device 12 includes a digitizing mechanism 18 for creating a digital image of physical information, such as carried by document 20, and for creating a digital tag from a physical tag (see below). Sending device 12 also may include a processor 22 for receiving, storing, reading, encrypting, and manipulating the digital image and digital tag and also may include a keypad 24 or other user interface, such as a keyboard, mouse, and/or display for controlling the sending device. After encrypting the digital image using a public key identified by document 20, the sending device may send the encrypted digital image to receiving device 16 through network 14. Receiving device 16 thus may decode the encrypted image using a private key that forms a key pair with the public key used for encryption.

Sending device 12 may take the form of any device or system of operatively connected devices that provide a digitizing mechanism; a processor; and memory for storing digitized information, instructions, and the like. Typically, the sending device is connected to a network over which it may send encrypted images to the receiving device. In addition, the sending device may include a printer or display mechanism to output information. Examples of such sending devices include multifunction peripherals (combined printer/photocopier/facsimile machines), processor-equipped facsimile machines, digital photocopiers, and optical scanners or digital cameras.

Network 14 is any set of connections that allows communication between sending device 12 and receiving device 16. A network may be configured as a local area network, for example, a network within a company. Alternatively, a network may be configured as a wide area network, thus allowing a user of the sending device to transmit the encrypted digital image over a great distance to the recipient device. The network may be a wired and/or wireless network. The network may store public keys and addresses that are identified by the physical tags, either on one server or in a distributed fashion on plural servers in the network. This distributed storage may circumvent the need for a single server or processor as a storage site for all public keys, when the public keys are not carried fully by the physical tags.

Receiving device 16 generally includes any device or system of operatively connected devices capable of receiving and decoding an encrypted digital image. Device 16 thus may include a processor 26 configured to decode the encrypted image using a private key generally stored in onboard memory within the device. Receiving device 16 also may include an output mechanism, such as printer 28 or display screen 30, to produce a hard copy or visual representation, respectively, of the decoded image. Moreover, receiving device 16 may include each of the mechanisms present in the sending device, to allow two-way exchange of encrypted images.

The digitizing mechanism of sending device 12 includes any mechanism for converting spatially-distributed physical information into a corresponding digital representation or image of the information, through optical or other physical properties of the physical information. The digitizing mechanism may create a digital image with a bit depth of 2, for information in black and white, or a bit depth of 8 to 24 (or more) for gray scale or color information. The optical properties may include reflectance, transmittance, refraction, diffraction, scattering, and luminescence, among others; may be measured as a function of intensity and/or wavelength; and may be absolute or relative, for example, relative to a substrate. Suitable digitizing mechanisms may include scanners, such as hand-held wands, sheet scanners, flat-bed scanners, overhead scanners, and the like. Suitable digitizing mechanisms also may include digital cameras. Digitizing mechanisms may use moving lasers, arrayed sensors such as CCD (charge coupled device) arrays, CMOS (complementary metal oxide semiconductor) arrays, and/or photomultiplier tubes, among others. Arrays of sensors may be linear, or two-dimensional in an orthogonal or non-orthogonal distribution. Digitizing mechanisms may move the sensors past the physical information or vice versa.

The physical information may be carried by a document, such as document 20 in FIG. 2. A document generally includes a substrate 32 and associated physical information 34 supported by the substrate. The physical information may be presented as text 36; handwriting or printing, such as signature 38; drawing 40; and/or picture 42. The physical information may be created by printing, typing, handwriting, sketching, drawing, photographic development, and/or painting, among others. The substrate may be paper, wood, metal, plastic, ceramic, canvas, or the like. Examples of documents may include single or multi-page printed reports; signed checks, contracts, or agreements; handwritten notes; blueprints or other technical plans, designs, or representations; artistic or informative renderings, such as sketches, paintings, and collages; and/or photographic/graphic negatives or prints. Alternatively, the physical information may be generally substrate-independent, such as a digital photograph.

As shown in FIG. 2, document 20 may be associated with a physical tag 44. Physical tag 44 may include any physical representation of a public key or of a public key identifier. The physical tag may be carried on a substrate 46, such as the depicted label, that is a component separate from document substrate 32. In this case, the physical tag may be associated with the document substrate by applying tag 44 to the document substrate, and fixing the tag's position using an adhesive or fastener, such as glue, tape, a staple, a clip, or other material. In some embodiments, the tag may be a peel-off adhesive label that is removed from a label carrier and applied to a suitable position on the document, generally an information-free region, and fixed in position using a pressing force. When the document includes more than one page or substrate component, the physical tag may be applied to each page or substrate component of the document. Alternatively, the physical tag may be applied to only one page or substrate component of the document, for example, the first or last page of the document. In some embodiments, sending device 12 may be configured to associate one physical tag with plural documents. For example, sending device 12 may be instructed to re-use the digital representation of the physical tag until the device receives an indication that a sending session has been completed.

The tag may remain associated with the document as an indicator of the document's digitization, transmittal, and/or destination. Alternatively, the tag may be abutted only temporarily with the document by placing the tag on the surface of the substrate, for example, by sandwiching the tag between the document and the scanning window of an optical scanner. In this case, the tag may be easily separated from the document after digitization, and the document then may be associated with additional tags for sending to other recipients. Alternatively, more than one tag may be associated with a document concurrently. In some embodiments, the physical tag is directly printed on the document substrate. In other embodiments, the physical tag does not contact the document directly, but is digitized in a separate step, generally before or after document digitization, for example, becoming associated with the document through temporal digitization or user input. In this case, the same or a different digitizing mechanism may be used to digitize the document and physical tag. In yet other embodiments, an image of a physical tag may be included in a digital photograph.

Physical tag 44 identifies a public key and also may identify an address to which the encrypted digital image is sent. The tag may identify a public key by carrying the entire public key, optionally in the form of a digital certificate in which the public key is encrypted with the private key of a trusted authority. Alternatively, the tag may identify the public key by carrying an identifier that allows the sending device to retrieve or read the public key, by identifying a storage location for the public key. The storage location may be at a distinct location on the document substrate, in memory of the sending device, or on a networked key server. The public key located on the sending device or key server may be in the form of a digital certificate. The physical tag may also identify an address, generally an address that contains or has access to the counterpart private key. The address may be an email address, a telephone number, a website address, or any other electronic location that directs digital communication. The address may be carried, in its entirety, by the physical tag, or may be stored elsewhere, such as in onboard memory of processor 22, for example, linked to a recipient's public key. When stored elsewhere, the physical tag may identify the digital storage location of the complete address.

Information identifying a public key and/or address may be carried by physical tag 44 in the form of characters, symbols, shapes, bars, dots, lines, bars, forward/backslashes, halftone patterns, and/or rectangles, among others. Thus, a public key, and, optionally, an address, may be identified by a string of characters and/or symbols, among others. For example, using a character code, the physical tag may be digitized, and optical character recognition software may be used to read the resulting digital tag according to the physical tag's corresponding characters and/or symbols.

In some embodiments, the public key is identified using coded information, such as a barcode, schematically represented by barcode 48 of FIGS. 2 and 3. A barcode generally includes any machine-readable one- or two-dimensional array of bars, lines, dashes, rectangles, dots, and/or other shapes. The relative or absolute positions, sizes, shapes, number, and/or orientations of the bars, lines, etc. may carry the coded information. Barcodes are generally black and white, for accurate reading of the code, but also may be gray scale or color. Barcode 48 is a schematic example of a linear barcode, which is a linear sequence of bars and spaces of one or more possible widths. Linear or one-dimensional barcodes may include CODABAR, Code 11, Code 39, Code 93, Code 128, EAN, Interleaved 2 of 5, Plessey Code, PLANET CODE, POSTNET, and UPC, among others. Systems for reading linear barcodes from a digital image are included, for example, in U.S. Pat. No. 5,276,315 to Surka, U.S. Pat. No. 5,329,104 to Ouchi et al., and U.S. Pat. No. 5,801,371 to Kahn et al., which are incorporated herein by this reference.

Alternatively, the barcode may be two-dimensional, having information displayed in two dimensions. A schematic representation of a two-dimensional barcode 148 on physical tag 144 is shown in FIG. 4. Examples of two-dimensional barcodes include 3-Di, ArrayTag, Aztec Code, Codablock, Code 1, Code 16K, Code 49, CP Code, DATA MATRIX, DATASTRIP CODE, Doct Code A, hueCode, Maxi Code, MiniCode, PDF 417, QR CODE, SmartCode, SUPERCODE, and ULTRACODE, among others. Systems for reading linear and two-dimensional barcodes from a digital image are available, for example, from SkySoft Express, Martinsried, Germany, and VisionShape, Inc., Placentia, Calif.

The physical tag may identify a public key (and address) using a barcode that forms a logo, picture, text, or design, among others, referred to as a “glyph code” as show in FIG. 5. A glyph code generally includes any barcode that contains, and often hides, machine-readable information in a graphic that may include a picture, a logo, text, and/or design. The glyph code may be informative, interesting, and/or pleasing for a person visually inspecting the code. Thus, the glyph code may allow a person to identify the intended recipient based on the presented logo, text, design, or picture. Here, barcode 248 of physical tag 244 spells out the intended recipient “JONES”, shown at 250. Barcode 248 schematically represents the DATAGLYPH code, described in U.S. Pat. No. 5,825,933 to Hecht. Systems for reading the DATAGLYPH code are described in U.S. Pat. No. 6,298,171 to Lorton et al. Both of these patents are incorporated herein by reference. Although the DATAGLYPH code is shown, any glyph code that embeds machine-readable information in a logo, text, design, and/or picture may be used.

The resolution at which the physical tag is created, the space available for a physical tag on a document, the resolution of the digitizing mechanism, the fraction of the physical tag devoted to redundancy and checking features, and/or the form (and thus size) of the public key may determine an appropriate barcode and information content for use on the physical tag. A public key is often about 1024 bits or about 128 bytes, and an average address, much less. Thus, a coding capacity of about 200 bytes may be sufficient for a barcode to carry a public key and an address, which is greater than the coding capacity of a typically-sized linear barcode. Furthermore, the public key may be included in a digital certificate, which may be about two kilobytes in size. Using printing and scanning technology at 300 dpi, for example, some two-dimensional barcodes may have a coding capacity of about one kilobyte per square inch. This coding capacity generally includes redundancy and checking features to ensure accurate retrieval of information from the physical tag. Thus, about two square inches may be sufficient to carry a digital certificate and address and about one-tenth this area for a public key and address alone. Higher or lower printing and scanning resolutions may be used with resulting tradeoffs of encoding density versus redundancy and robustness. With printing and scanning at 300 dpi, linear and smaller two-dimensional barcodes may be more suitable to identify a storage location for a public key, whereas larger or higher density two-dimensional barcodes may be more suitable to carry the entire public key, and, optionally, digital certificate and recipient's address.

Physical tags may include text or pattern information 50, 250. Text information 50 may be a literal translation of the barcode and/or may provide a person with the ability to visually identify the key holder linked to the physical tag. Thus, as shown in FIGS. 3 and 4, the tag for sending information to “JONES, INC.” is readily identifiable as such. In some embodiments, text information alternatively, or in addition, may include an identifying number or alphanumeric string. With the use of a glyph code, shown in FIG. 5, the name 250, logo, or other identifying aspect of the recipient may be illustrated graphically as part of the barcode.

The positions occupied by physical tags on documents may be selected by each user or may be restricted to a predetermined, distinct region of the documents. When selectable, the physical tag may be associated with the document at any desired position on the document substrate, and may have any orientation. Asymmetric codes, particularly codes with orienting marks or symbols, may facilitate locating and orienting the tag, and reading information on the physical tag after digitization. Alternatively, the physical tag may be associated with a predetermined position on the substrate. For example, sending device 12 may recognize a physical tag positioned in the upper right hand corner of a document, in a particular orientation, to facilitate distinguishing the tag from the document.

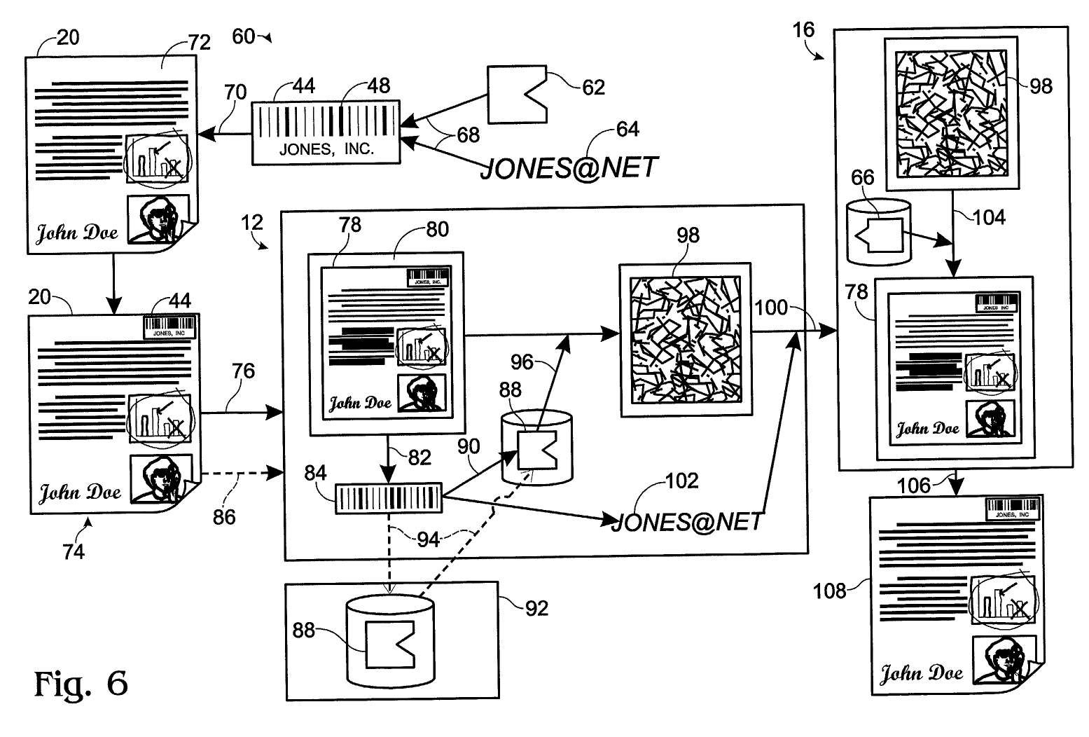

FIG. 6 shows, at 60, a method for sending an encrypted image of a document using a physical tag 44 to identify a public key and an address. In method 60, sending device 12 digitizes and encrypts document 20 and sends it to receiving device 16. Physical tag 44 carries a barcode 48 that identifies a public key 62 and an address 64. Generally, the address corresponds to receiving device 16, which stores, or has access to, a private key 66 that forms a key pair with public key 62. As described above, the information-coding capacity of the barcode may determine if the public key and address are fully encoded by the barcode, or their storage locations are encoded by the barcode. Encoding is shown at 68. As shown at 70, physical tag 44 may be affixed to document 20, generally on an information-free region 72 of the document.

The resulting tagged document 74 is digitized, shown at 76, to convert the document into a digital image 78, generally stored in memory 80 of sending device 12. The digital image may include digital information produced from the physical tag. Using digital instructions specific to barcode 48, an image of the barcode may be extracted, shown at 82, to create a digital tag 84 corresponding to the information carried by physical tag 44. Alternatively, as shown at 86, the physical tag may be converted to digital tag 84 with a separate digitizing step. The separate digitizing step may be carried out specifically on the physical tag, using either the same or a distinct digitizing mechanism, either at the same or a distinct resolution.

Encrypting digital image 78 is carried out using public key 88, which carries the information of public key 62, but in a different form. The public key may be read directly from digital tag 84, shown at 90, may be read from another region of the digital image indicated by the digital tag, or may be obtained from a site where the public key is stored on a digital storage medium, such as public key server 92 (or the sending processor), shown at 94, based on a storage location read from digital tag 84. When the public key is carried by, or obtained as, a digital certificate, sending device 12 first may verify the public key using a public key provided by the creator of the digital certificate (not shown). Thus, subsequent steps may be dependent upon successful verification. Encrypting digital image 78 with public key 88, shown at 96, produces encrypted digital image 98. This encrypted image is not intelligible without decoding. Here, the digital tag is included in the encrypted digital image, in encrypted form. However, in other embodiments, the digital tag may be removed from the digital image before encryption (or after decoding at receiving device 16).

The encrypted image is sent to receiving device 16, through network 14, shown at 100. The destination is determined by an address, either supplied separately by a sender, or identified by physical tag 44. Here, address 102, which corresponds to address 64, is carried by digital tag 84 and is read directly from the digital tag. Alternatively, address 102 may be stored in memory, and its stored location may be identified by an address identifier in the digital tag. Along with the encrypted image, the sender may include a digital signature that relates to the size and content of the digital image. This digital signature may be a hash value produced from the digital image, either before or after encryption, using a one-way hashing function, such as a digital signature algorithm. Encryption of the hash value with the sender's private key produces the digital signature. In this case, the sender also may include the sender's public key, allowing the recipient to verify the digital signature. The digital signature may be used to verify that the decoded digital image has not been altered and was sent by a holder of the sender's private key.

After receipt by receiving device 16, the device decodes the encrypted image, shown at 104, using counterpart private key 66. The decoded image may correspond substantially to digital image 78 prior to encryption or may lack the digital tag. The decoded image may be printed, shown at 106, to produce a hard copy 108 of tagged document 74.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

We claim:

1. A method of encrypting an image produced from physical information, comprising:
digitizing spatially-distributed physical information to create a digital image of the information;
digitizing a physical tag associated with the physical information to create a digital tag, the digital tag being readable to identify a public key;
reading the digital tag to identify the public key; and
encrypting the digital image with the identified public key.

2. The method of claim 1, further comprising physically associating the physical tag with the physical information.

3. The method of claim 1, wherein the physical information is included in a document, the document having a substrate that supports the physical information.

4. The method of claim 3, wherein the physical tag is included on a label that is applied to the document.

5. The method of claim 1, wherein the physical tag includes a barcode that identifies the public key.

6. The method of claim 5, wherein the barcode is formed as a glyph code, and wherein the glyph code contains public-key identifying information in a machine-readable graphic.

7. The method of claim 1, wherein the physical tag carries the public key.

8. The method of claim 1, wherein the physical tag identifies a location on a digital storage medium, and wherein the location includes the public key.

9. The method of claim 1, further comprising sending the encrypted digital image from a sender to an address of a recipient, the address being identified by the physical tag.

10. The method of claim 9, wherein sending includes transmitting a digital signature to the recipient, the digital signature being produced using a private key of the sender and relating to the digital image.

11. The method of claim 1, wherein digitizing the physical tag is carried out during digitizing the physical information using a single digitizing mechanism.

12. The method of claim 11, further comprising removing the digital tag at least substantially from the digital image before encrypting.

13. A method of sending an encrypted image of a document, comprising:
disposing a physical tag on a document, the physical tag having a code that carries a public key;
digitizing the document to create a digital image that includes a digital representation of the code;
reading the digital representation of the code to obtain the public key;
encrypting the digital image with the obtained public key; and
sending the encrypted image to a recipient that holds a private key, the private key forming a key pair with the public key.

14. The method of claim 13, wherein the code includes a barcode.

15. The method of claim 13, wherein the physical tag carries an address, the address corresponding to the recipient.

16. The method of claim 13, wherein the code is formed as a glyph code, and wherein the glyph code carries the public key in a machine-readable graphic.

17. The method of claim 13, wherein the physical tag is included on an adhesive label, and wherein disposing includes applying the adhesive label to the document.

18. A device for encrypting an image produced from spatially-distributed physical information, the device comprising:
at least one digitizing mechanism adapted to digitize spatially-distributed physical information to create a digital image, and to digitize a physical tag associated with the physical information to create a digital tag, the digital tag being readable to identify a public key; and
a processor operatively connected to the digitizing mechanism and adapted to receive the digital image and digital tag from the at least one digitizing mechanism, to read the digital tag to identify the public key, and to encrypt the image with the identified public key.

19. The device of claim 18, wherein the physical information is included in a document, the document having a substrate that supports the physical information.

20. The device of claim 19, wherein the physical tag is included on a label that is applied to the document, the label having a code that identifies the public key.

21. The device of claim 18, wherein the at least one digitizing mechanism is a single mechanism that digitizes the physical tag during digitizing the physical information.

22. The device of claim 18, wherein the physical tag carries an address of a recipient, and the processor is adapted to be connected to a network and to send the encrypted image to the address through the network.

23. The device of claim 18, wherein the physical tag includes a barcode that identifies the public key.

24. The device of claim 23, wherein the barcode is formed as a glyph code, and wherein the glyph code contains public-key identifying information in a machine-readable graphic.

25. The device of claim 18, wherein the physical tag carries the public key.

26. The device of claim 18, wherein the physical tag identifies a location on a digital storage medium, and wherein the location includes the public key.

27. A program storage device readable by a processor, tangibly embodying a program of instructions executable by the processor to perform method steps for encrypting an image produced from physical information, comprising:
digitizing spatially-distributed physical information to create a digital image of the information;
digitizing a physical tag associated with the physical information to create a digital tag, the digital tag being readable to identify a public key;
reading the digital tag to identify the public key; and
encrypting the digital image with the identified public key.

28. The program storage device of claim 27, wherein the physical information is included in a document, the document having a substrate that supports the physical information.

29. The program storage device of claim 28, wherein the physical tag is included on a label that is applied to the document.

30. The program storage device of claim 27, wherein the physical tag includes a barcode that identifies the public key.
